(19) United States
(12) Patent Application Publication
(10) Pub. No.: US 2026/0206021 A1
(43) Pub. Date: Jul. 16, 2026

(54) INTERFERENCE ESTIMATION USING NULL RESOURCE ELEMENTS

(71) Applicant: QUALCOMM Incorporated, San Diego, CA (US)

(72) Inventors: Chih-Hao LIU, San Diego, CA (US); Jing SUN, San Diego, CA (US)

(21) Appl. No.: 19/020,732

(22) Filed: Jan. 14, 2025

(51) Int. Cl. H04W 72/12; H04W 72/0446; H04W 72/231; H04W 72/541

(52) U.S. Cl. CPC H04W 72/12; H04W 72/0446; H04W 72/231; H04W 72/541

(57) ABSTRACT

Various aspects of the present disclosure generally relate to wireless communication. In some aspects, a transmitter may obtain a scheduling configuration associated with a start and length indicator value defining a time period including at least one slot that does not include a scheduled demodulation reference signal, wherein the scheduling configuration indicates a scheduling pattern for a plurality of resource elements (REs) in the at least one slot, wherein the plurality of REs includes at least one set of null REs. The transmitter may transmit one or more transport blocks according to the scheduling configuration. Numerous other aspects are described.

### FIELD OF THE DISCLOSURE

Aspects of the present disclosure generally relate to wireless communication and specifically relate to techniques, apparatuses, and methods associated with interference estimation using null resource elements.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In a wireless network, physical uplink shared channels (PUSCHs) and physical downlink shared channels (PDSCHs) are components of uplink and downlink communication, respectively, between a transmitter (e.g., a user equipment (UE) and/or a network node) and a receiver (e.g., a UE and/or a network node). For example, data may be transmitted from a network node to a UE on a PDSCH and data may be transmitted from a UE to a network node on a PUSCH. PxSCH (e.g., PUSCH and/or PDSCH) communications may be mapped onto a physical layer that is divided into time resources (e.g., slots) and frequency resources (e.g., resource blocks). In some network configurations, a start and length indicator value (SLIV) configuration may be adapted to enable a PxSCH to be allocated across a slot boundary, which may also enable a demodulation reference signal to be utilized across more than one slot (e.g., in adjacent slots).

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram showing an example downlink-centric slot or communication structure and an uplink-centric slot or communication structure in accordance with the present disclosure.

FIG. 4 is a diagram illustrating an example of a slot format, in accordance with the present disclosure.

FIG. 5 is a diagram illustrating an example of physical channels and reference signals in a wireless network, in accordance with the present disclosure.

FIGS. 6A-6C are diagrams illustrating examples of start and length indicator value designs for physical uplink shared channel and/or physical downlink shared channel transmissions, in accordance with the present disclosure.

FIG. 7 is a diagram illustrating an example associated with interference estimation using null resource elements (REs), in accordance with the present disclosure.

FIG. 8 is a diagram illustrating an example associated with interference estimation using null REs, in accordance with the present disclosure.

FIGS. 9A-9D are diagrams illustrating examples associated with interference estimation using null REs, in accordance with the present disclosure.

FIG. 10 is a diagram illustrating an example process performed, for example, at a transmitter or an apparatus of a transmitter, in accordance with the present disclosure.

FIG. 11 is a diagram illustrating an example process performed, for example, at a receiver or an apparatus of a receiver, in accordance with the present disclosure.

FIGS. 12-13 are diagrams of example apparatuses for wireless communication, in accordance with the present disclosure.

### SUMMARY

Some aspects described herein relate to a transmitter for wireless communication. The transmitter may include one or more memories and one or more processors coupled to the one or more memories. The one or more processors may be configured to obtain a scheduling configuration associated with a start and length indicator value (SLIV) defining a time period including at least one slot that does not include a scheduled demodulation reference signal (DMRS), wherein the scheduling configuration indicates a scheduling pattern for a plurality of resource elements (REs) in the at least one slot, wherein the plurality of REs includes at least one set of null REs. The one or more processors may be configured to transmit one or more transport blocks (TBs) according to the scheduling configuration.

Some aspects described herein relate to a receiver for wireless communication. The receiver may include one or more memories and one or more processors coupled to the one or more memories. The one or more processors may be configured to receive, from a transmitter, one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The one or more processors may be configured to perform at least one interference estimation associated with the plurality of REs.

Some aspects described herein relate to a method of wireless communication performed by a transmitter. The method may include obtaining a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The method may include transmitting one or more TBs according to the scheduling configuration.

Some aspects described herein relate to a method of wireless communication performed by a receiver. The method may include receiving, from a transmitter, one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The method may include performing at least one interference estimation associated with the plurality of REs.

Some aspects described herein relate to a non-transitory computer-readable medium that stores a set of instructions for wireless communication by a transmitter. The set of instructions, when executed by one or more processors of the transmitter, may cause the transmitter to obtain a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The set of instructions, when executed by one or more processors of the transmitter, may cause the transmitter to transmit one or more TBs according to the scheduling configuration.

Some aspects described herein relate to a non-transitory computer-readable medium that stores a set of instructions for wireless communication by a receiver. The set of instructions, when executed by one or more processors of the receiver, may cause the receiver to receive, from a transmitter, one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The set of instructions, when executed by one or more processors of the receiver, may cause the receiver to perform at least one interference estimation associated with the plurality of REs.

Some aspects described herein relate to an apparatus for wireless communication. The apparatus may include means for obtaining a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The apparatus may include means for transmitting one or more TBs according to the scheduling configuration.

Some aspects described herein relate to an apparatus for wireless communication. The apparatus may include means for receiving, from a transmitter, one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The apparatus may include means for performing at least one interference estimation associated with the plurality of REs.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, physical uplink shared channels (PUSCHs) and physical downlink shared channels (PDSCHs) are components of uplink and downlink communication, respectively, between a transmitter (e.g., a user equipment (UE) and/or a network node) and a receiver (e.g., a UE and/or a network node). For example, data may be transmitted from a network node to a UE on a PDSCH and data may be transmitted from a UE to a network node on a PUSCH. PxSCH (e.g., PUSCH and/or PDSCH) communications may be mapped onto a physical layer that is divided into time resources (e.g., slots) and frequency resources (e.g., resource blocks (RBs)). A UE and/or a network node may utilize repeated PxSCH transmissions with multiple segments of adjacent (e.g., back-to-back) symbols to extend the coverage of a PxSCH communication, where each repetition segment may be confined to the boundaries of a transmission slot.

A start and length indicator value (SLIV) may be used to indicate the length of a slot, which can vary depending on the subcarrier spacing associated with network configurations. For example, the SLIV may be utilized to map time and frequency resources for efficient resource allocation and scheduling in PUSCH communications from a UE to a network node. In some network configurations, a SLIV configuration may be adapted to enable a PxSCH to be allocated across a slot boundary, which may also enable a demodulation reference signal (DMRS) to be utilized across more than one slot (e.g., in adjacent slots).

However, because a UE and/or a network node may rely on DMRS symbols to capture bursty interference (e.g., interference occurring in short, irregular bursts) in a network, SLIV configurations that enable a PxSCH to be allocated across the slot boundary may increase the probability that bursty interference interacts with a slot that does not contain a DMRS symbol. As a result, the use of SLIV configurations containing slots with no DMRS symbols may reduce the accuracy of estimating interference where the UE and/or network node fail to capture instances of bursty interference occurring in one or more slots not containing DMRS symbols.

Various aspects relate generally to scheduling configurations associated with a SLIV defining a time period including at least one slot having no DMRS symbols, where the scheduling configuration indicates a scheduling pattern for at least one set of resource elements (REs) including at least one set of null REs. Some aspects more specifically relate to the scheduling pattern being associated with a cell identification of a cell that is associated with a transmitter (e.g., a UE and/or a network node). In some aspects, the scheduling pattern may indicate scheduling of a null RE in every X symbols within a physical RB group (PRG) according to a periodicity and/or in every Y RBs within a symbol according to a range associated with a number of RBs. In some aspects, the value of X and/or the value of Y may be associated with a cell identification of a cell that is associated with the transmitter. Additionally, in some aspects, the scheduling pattern may indicate that each null RE is scheduled in a different symbol and in a different tone within a PRG of each slot. In some aspects, the scheduling configuration indicates that more than one null RE may be capable of being scheduled in a symbol. In some aspects, the scheduling pattern may indicate the scheduling of each null RE in a different tone of each symbol according to a reference tone and a tone offset. Additionally, in some aspects, the tone offset may be associated with at least one of a cell identification of a cell associated with the transmitter, a symbol index, or a slot index. In some aspects, the transmitter may receive an updated scheduling pattern including an updated set of null REs. Additionally, in some aspects, the transmitter may puncture one or more REs by one or more null REs based at least in part on the scheduling configuration. In some aspects, the transmitter may rate match each RE around at least one set of null REs based at least in part on the scheduling configuration.

Particular aspects of the subject matter described in this disclosure can be implemented to realize one or more of the following potential advantages. In some examples, the described techniques can be used to enable interference estimation in time periods that have one or more slots that do not include a DMRS symbol. For example, because bursty interference may not be captured in a slot that does not contain a DMRS symbol, a scheduling configuration including null REs within this slot may enable the bursty interference to be captured and utilized for interference estimation. Additionally, by associating the scheduling pattern with a cell identification of a cell associated with the transmitter, a transmitter may capture and/or distinguish interference in examples where two transmitters may be served by two neighboring cells that are configured with the same null RE scheduling pattern, where the interference may not otherwise be captured because of the lack of differentiation between the scheduled null RE patterns. In some examples, by scheduling a null RE in every X symbols within a PRG according to a periodicity and/or in every Y RBs within a symbol according to a range associated with a number of RBs, interference measurements may be captured consistently across time and/or frequency resources, thereby enabling accurate measurement of interference that may be constant or near-constant across a PRG and increasing the probability of capturing short, isolated instances of interference. Additionally, where the scheduling pattern indicates that each null RE is scheduled in a different symbol and in a different tone within a PRG of each slot, bursty interference may be more widely captured across the time and frequency domains. Similarly, by scheduling more than one null RE in one or more symbols, the transmitter may have an increased probability of capturing short, isolated instances of interference as well as interference that is consistent across frequency resources. In some examples, by indicating a scheduling pattern of null REs according to a reference tone and a tone offset, the transmission overhead of the scheduling pattern may be reduced, relative to indicating the scheduling pattern according to a scheduling indication for each null RE, thereby reducing power consumption and network traffic. Additionally, by providing one or more updated scheduling patterns to the transmitter, the scheduling of null REs may be adapted to changing network conditions (e.g., increased interference, decreased interference, or the like), thereby enabling increased accuracy in estimating interference. In some examples, by puncturing one or more REs by one or more null REs, the transmitter may adapt transmissions to different channel conditions in order to decrease transmission overhead as well as to increase the probability of capturing interference where channel conditions include increased instances of interference. Similarly, by rate matching each RE around at least one set of null REs, the transmitter may adapt transmissions to different channel conditions in order to decrease transmission overhead, thereby increasing efficiency of resource allocation while enabling capture of interference in relevant slots.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

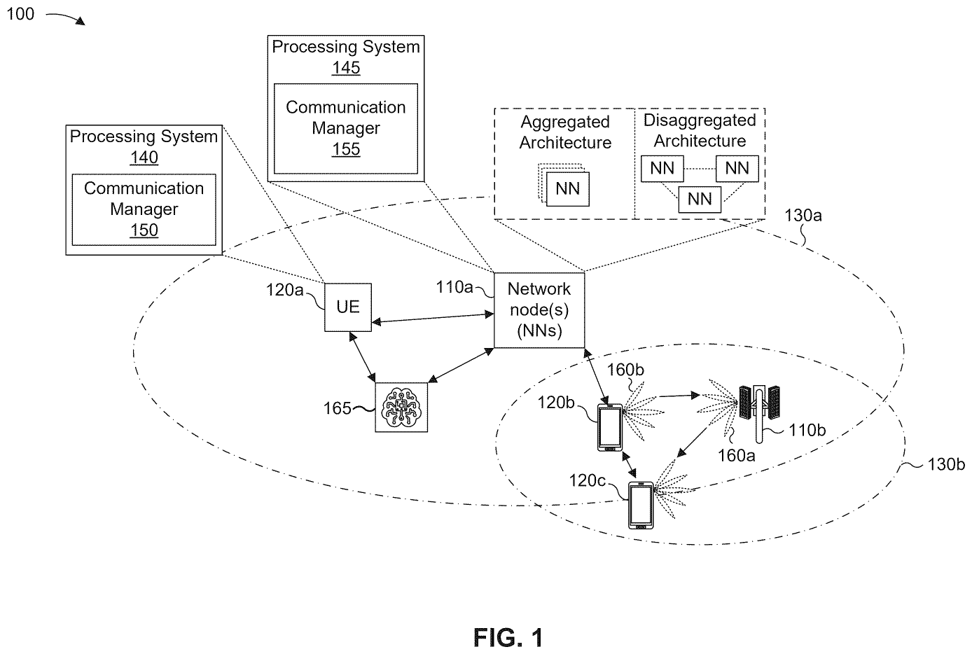

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally, or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally, or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

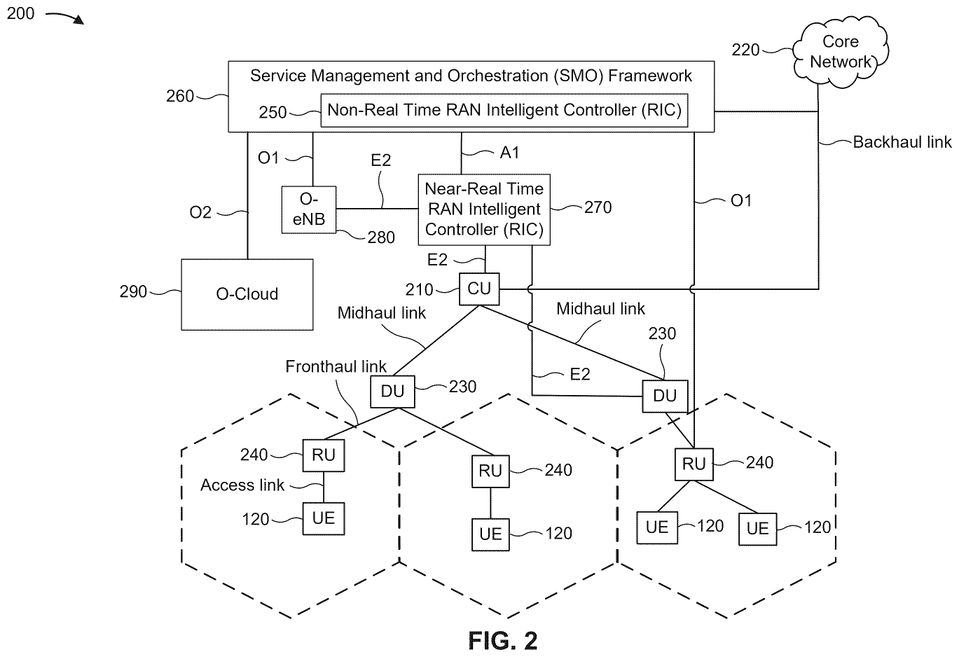

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, RBs, and REs), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH RB indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE may include a communication manager 150. In some aspects, the network node 110 may include a communication manager 155. As described in more detail elsewhere herein, the communication manager 150 and/or the communication manager 155 may obtain a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs; and transmit one or more TBs according to the scheduling configuration.

Additionally, or alternatively, the communication manager 150 and/or the communication manager 155 may receive one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs; and perform at least one interference estimation associated with the plurality of REs. Additionally, or alternatively, the communication manager 150 and/or the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

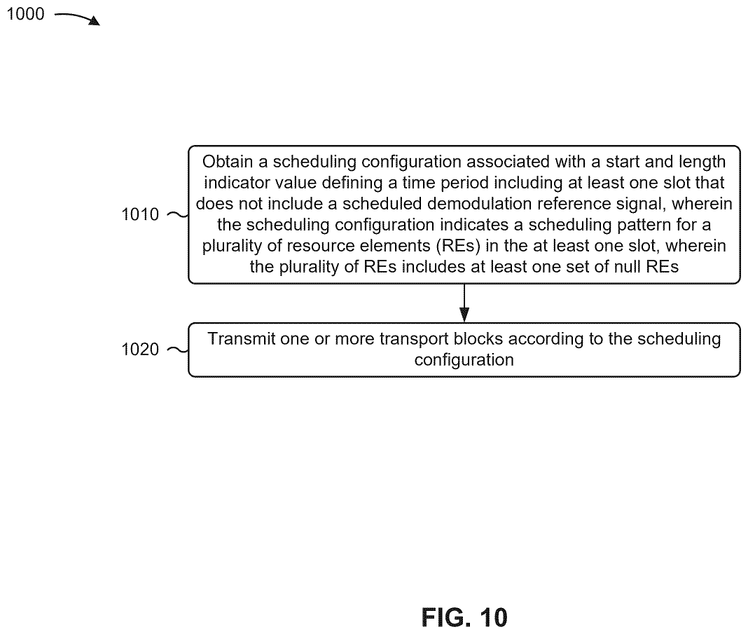

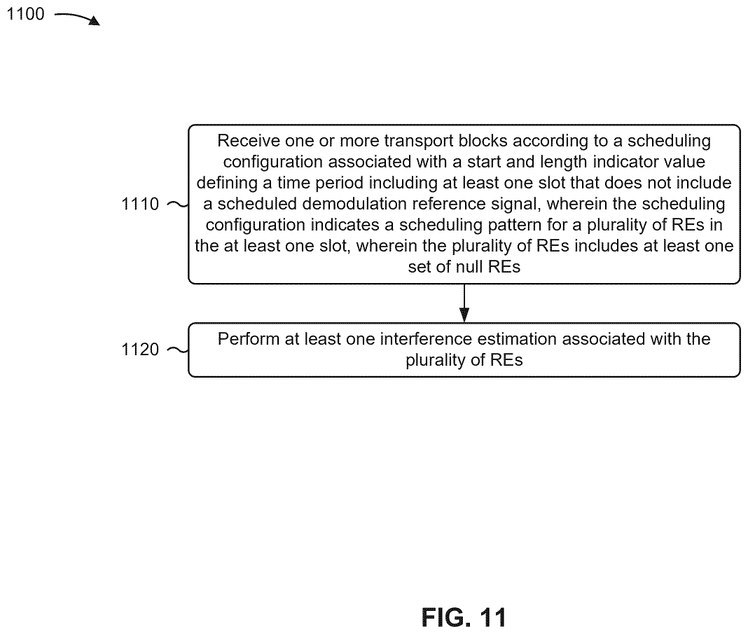

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with interference estimation using null REs, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). In some aspects, the transmitter or receiver described herein is the network node 110, is included in the network node 110, or includes one or more components of the network node 110 shown in FIG. 1. In some aspects, the transmitter or receiver described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, the processing system 145 or the processing system 140 of the network node 110), the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

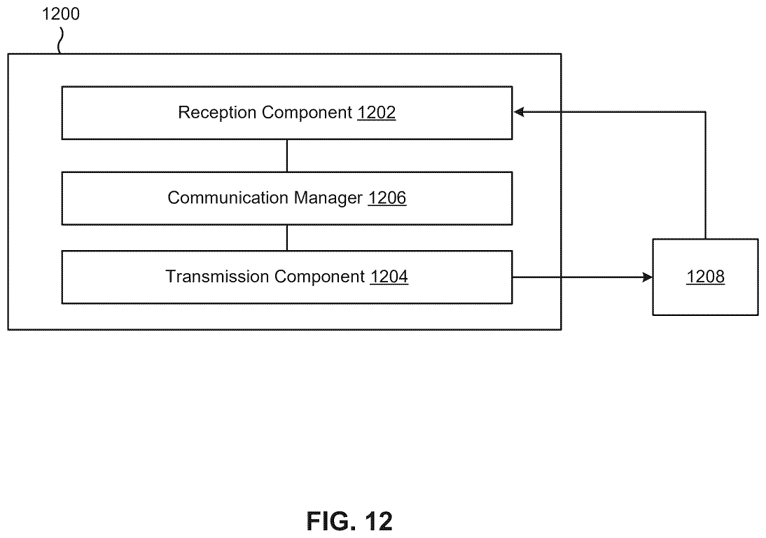

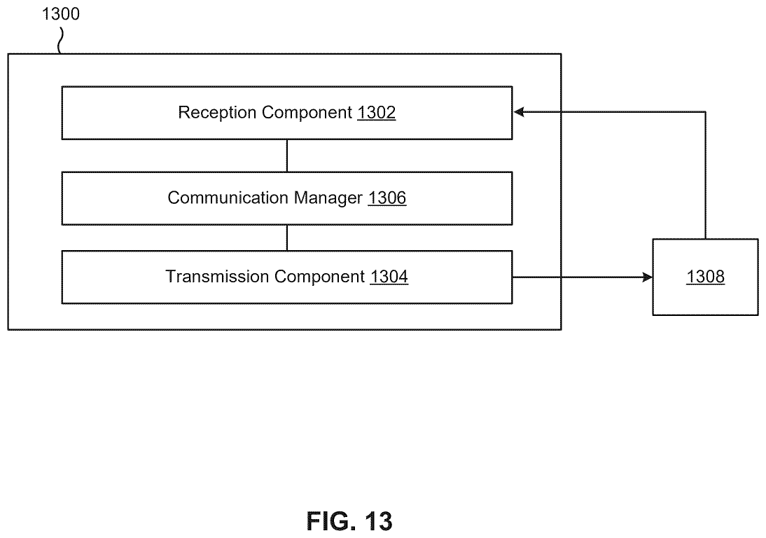

In some aspects, a transmitter includes means for obtaining a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs; and/or means for transmitting one or more TBs according to the scheduling configuration. In some aspects, the means for the transmitter to perform operations described herein may include, for example, one or more of communication manager 150, communication manager 155, processing system 140, processing system 145, a radio, one or more RF chains, one or more transceivers, one or more antennas, one or more modems, a reception component (for example, reception component 1202 depicted and described in connection with FIG. 12 or reception component 1302 depicted and described in connection with FIG. 13), and/or a transmission component (for example, transmission component 1204 depicted and described in connection with FIG. 12 or transmission component 1304 depicted and described in connection with FIG. 13), among other examples. In some aspects, the means for the transmitter to perform operations described herein may include, for example, one or more of communication manager 150, communication manager 155, processing system 140, processing system 145, a radio, one or more RF chains, one or more transceivers, one or more antennas, one or more modems, a reception component (for example, reception component 1202 depicted and described in connection with FIG. 12 or reception component 1302 depicted and described in connection with FIG. 13), and/or a transmission component (for example, transmission component 1204 depicted and described in connection with FIG. 12 or transmission component 1304 depicted and described in connection with FIG. 13), among other examples.

In some aspects, a receiver includes means for receiving, from a transmitter, one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs; and/or means for performing at least one interference estimation associated with the plurality of REs. In some aspects, the means for the receiver to perform operations described herein may include, for example, one or more of communication manager 150, communication manager 155, processing system 140, processing system 145, a radio, one or more RF chains, one or more transceivers, one or more antennas, one or more modems, a reception component (for example, reception component 1202 depicted and described in connection with FIG. 12 or reception component 1302 depicted and described in connection with FIG. 13), and/or a transmission component (for example, transmission component 1204 depicted and described in connection with FIG. 12 or transmission component 1304 depicted and described in connection with FIG. 13), among other examples. In some aspects, the means for the receiver to perform operations described herein may include, for example, one or more of communication manager 150, communication manager 155, processing system 140, processing system 145, a radio, one or more RF chains, one or more transceivers, one or more antennas, one or more modems, a reception component (for example, reception component 1202 depicted and described in connection with FIG. 12 or reception component 1302 depicted and described in connection with FIG. 13), and/or a transmission component (for example, transmission component 1204 depicted and described in connection with FIG. 12 or transmission component 1304 depicted and described in connection with FIG. 13), among other examples.

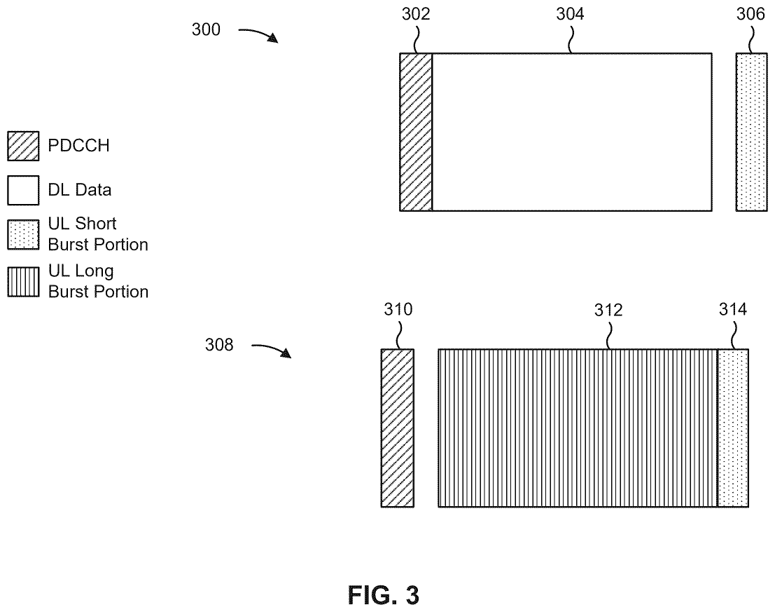

FIG. 3 is a diagram showing an example downlink (DL)-centric slot or communication structure 300 and an uplink (UL)-centric slot or communication structure 310 in accordance with the present disclosure. The DL-centric slot (or wireless communication structure) 300 may include a control portion 302 during which the scheduling entity (e.g., a UE or a network node) transmits various scheduling information or control information corresponding to various portions of the DL-centric slot to the subordinate entity (e.g., a UE). The control portion 302 may exist in the initial or beginning portion of the DL-centric slot 300. In some configurations, the control portion 302 may be a physical DL control channel PDCCH, as indicated in FIG. 3. In some examples, the control portion 302 may include legacy PDCCH information, shortened PDCCH (sPDCCH) information), a control format indicator (CFI) value (e.g., carried on a physical control format indicator channel (PCFICH)), one or more grants (e.g., DL grants, or UL grants), among other examples, or combinations thereof.

The DL-centric slot 300 may also include a DL data portion 304 during which the scheduling entity (e.g., a UE or a network node) transmits DL data to the subordinate entity (e.g., a UE) using communication resources utilized to communicate DL data. The DL data portion 304 may sometimes be referred to as the payload of the DL-centric slot 300. In some configurations, the DL data portion 304 may be a PDSCH.

The DL-centric slot 300 may also include an UL short burst portion 306 during which the subordinate entity (e.g., a UE) transmits reference signals or feedback to the scheduling entity (e.g., a UE or a network node) using communication resources utilized to communicate UL data. The UL short burst portion 306 may sometimes be referred to as an UL burst, an UL burst portion, a common UL burst, a short burst, an UL short burst, a common UL short burst, a common UL short burst portion, or various other suitable terms. In some aspects, the UL short burst portion 306 may include one or more reference signals. Additionally, or alternatively, the UL short burst portion 306 may include feedback information corresponding to various other portions of the DL-centric slot 300. For example, the UL short burst portion 306 may include feedback information corresponding to the control portion 302 or the data portion 304. Non-limiting examples of information that may be included in the UL short burst portion 306 include an ACK signal (for example, a PUCCH ACK, a PUSCH ACK, or an immediate ACK), a NACK signal (for example, a PUCCH NACK, a PUSCH NACK, or an immediate NACK), a scheduling request (SR), a buffer status report (BSR), a HARQ indicator, a CSI, a channel quality indicator (CQI), a SRS, a DMRS, PUSCH data, or various other suitable types of information. For example, a DMRS may be transmitted in a slot to enable a receiver to estimate characteristics of a radio channel, including desired signals and any interference present in the channel. As a result, the receiver may utilize the received DMRS to estimate whether and to what extent a signal is being affected by interference by comparing the received DMRS with an expected DMRS in order to determine the effects of the channel on the signal. The UL short burst portion 306 may include additional or alternative information, such as information pertaining to RACH procedures, scheduling requests, and various other suitable types of information.

As illustrated in FIG. 3, the end of the DL data portion 304 may be separated in time from the beginning of the UL short burst portion 306. This time separation may sometimes be referred to as a gap, a guard period, a guard interval, or various other suitable terms. This separation provides time for the switch-over from DL communication (for example, reception operation by the subordinate entity (e.g., a network node or a UE)) to UL communication (for example, transmission by the subordinate entity (e.g., a UE)). The foregoing provides some examples of a DL-centric wireless communication structure, but alternative structures having similar features may exist without deviating from the aspects described herein.

The UL-centric slot (or wireless communication structure) 308 may include a control portion 310. The control portion 310 may exist in the initial or beginning portion of the UL-centric slot 308. The control portion 310 may be similar to the control portion 302 described above with reference to the DL-centric slot 300. The UL-centric slot 308 may also include an UL long burst portion 312. The UL long burst portion 312 may sometimes be referred to as the payload of the UL-centric slot 308. The UL portion may refer to the communication resources utilized to communicate UL data from the subordinate entity (e.g., a UE) to the scheduling entity (e.g., a UE or a network node). In some configurations, the control portion 310 may be a physical DL control channel PDCCH.

As illustrated, the end of the control portion 310 may be separated in time from the beginning of the UL long burst portion 312. This time separation may sometimes be referred to as a gap, guard period, guard interval, or various other suitable terms. This separation provides time for the switch-over from DL communication (e.g., reception operation by the scheduling entity) to UL communication (e.g., transmission operation by the scheduling entity).

The UL-centric slot 308 may also include an UL short burst portion 314. The UL short burst portion 314 may be similar to the UL short burst portion 306 described above with reference to the DL-centric slot 300, and may include any of the information described above. The foregoing is merely one example of an UL-centric wireless communication structure, and alternative structures having similar features may exist without deviating from the aspects described herein.

In one example, a wireless communication structure, such as a frame, may include both UL-centric slots and DL-centric slots. In this example, the ratio of UL-centric slots to DL-centric slots in a frame may be dynamically adjusted based at least in part on the amount of UL data and the amount of DL data that are transmitted. For example, if there is more UL data, then the ratio of UL-centric slots to DL-centric slots may be increased. Conversely, if there is more DL data, then the ratio of UL-centric slots to DL-centric slots may be decreased.

As indicated above, FIG. 3 is provided as an example. Other examples may differ from what is provided with regard to FIG. 3.

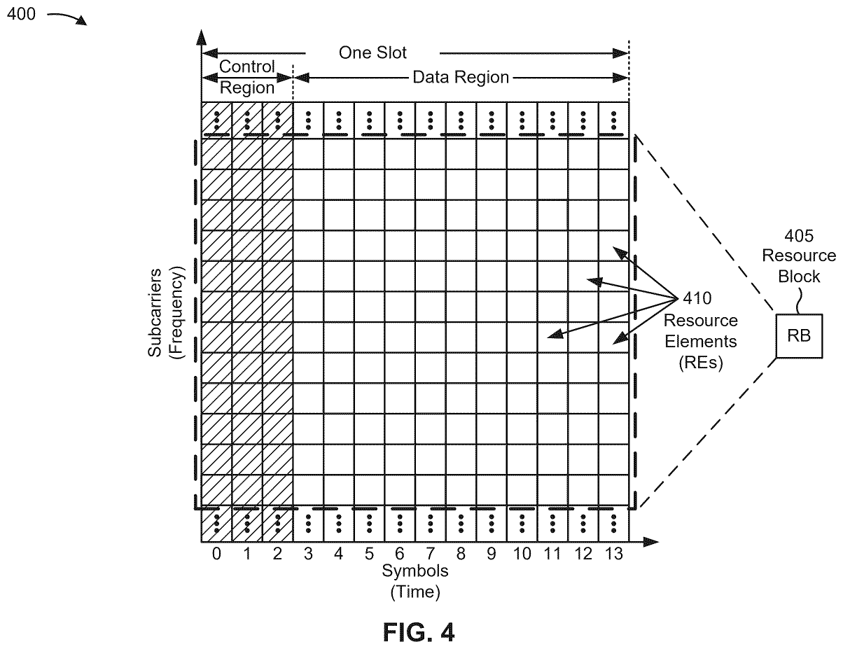

FIG. 4 is a diagram illustrating an example 400 of a slot format, in accordance with the present disclosure. As shown in FIG. 4, time-frequency resources in a radio access network may be partitioned into RBs, shown by a single RB 405. An RB 405 is sometimes referred to as a physical RB (PRB). An RB 405 includes a set of subcarriers (e.g., 12 subcarriers) and a set of symbols (e.g., 14 symbols) that are schedulable by a network node 110 as a unit. In some examples, an RB 405 may include a set of subcarriers in a single slot. As shown, a single time-frequency resource included in an RB 405 may be referred to as an RE 410. An RE 410 may include a single subcarrier (e.g., in frequency) and a single symbol (e.g., in time). A symbol may be referred to as an OFDM symbol. An RE 410 may be used to transmit one modulated symbol, which may be a real value or a complex value.

In some telecommunication systems (e.g., NR), RBs 405 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., DL or UL) for transmission. In some examples, the link direction for a slot may be dynamically configured.

As indicated above, FIG. 4 is provided as an example. Other examples may differ from what is described with respect to FIG. 4.

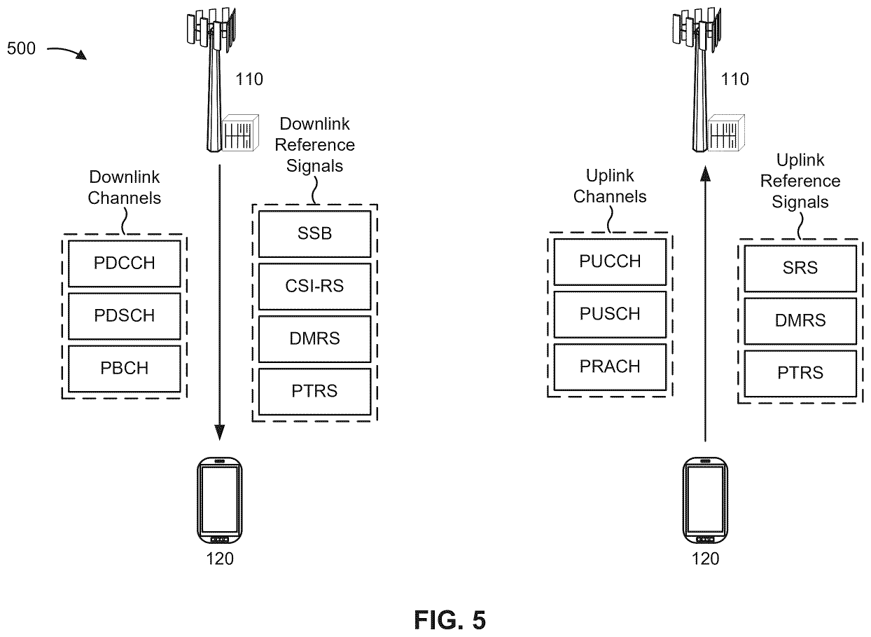

FIG. 5 is a diagram illustrating an example 500 of physical channels and reference signals in a wireless network, in accordance with the present disclosure. As shown in FIG. 5, DL channels and DL reference signals may carry information from a network node 110 to a UE 120, and UL channels and UL reference signals may carry information from a UE 120 to a network node 110.

As shown, a DL channel may include a PDCCH that carries DCI, a PDSCH that carries DL data, or a PBCH that carries system information, among other examples. In some aspects, PDSCH communications may be scheduled by PDCCH communications. As further shown, a UL channel may include a PUCCH that carries UCI, a PUSCH that carries UL data, or a physical random access channel (PRACH) used for initial network access, among other examples. In some aspects, the UE 120 may transmit ACK or NACK feedback (e.g., ACK/NACK feedback or ACK/NACK information) in UCI on the PUCCH and/or the PUSCH.

As further shown, a DL reference signal may include a synchronization signal block (SSB), a CSI-RS, a DMRS, a positioning reference signal (PRS), or a phase tracking reference signal (PTRS), among other examples. As also shown, a UL reference signal may include an SRS, a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for DL channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for DL communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both DL communications and UL communications. For example, DMRSs may be included in an uplink communication to enable a receiver to estimate characteristics of a radio channel, including desired signals and any interference present in the channel. Accordingly, the receiver may utilize the received DMRS to estimate whether and to what extent a signal is being affected by interference by comparing the received DMRS with an expected DMRS in order to determine the effects of the channel on the signal.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for UL channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as UL CSI acquisition, DL CSI acquisition for reciprocity-based operations, UL beam management, among other examples. The network node 110 may measure the SRSs, may perform channel estimation based at least in part on the measurements, and may use the SRS measurements to configure communications with the UE 120.

As indicated above, FIG. 5 is provided as an example. Other examples may differ from what is described with regard to FIG. 5.

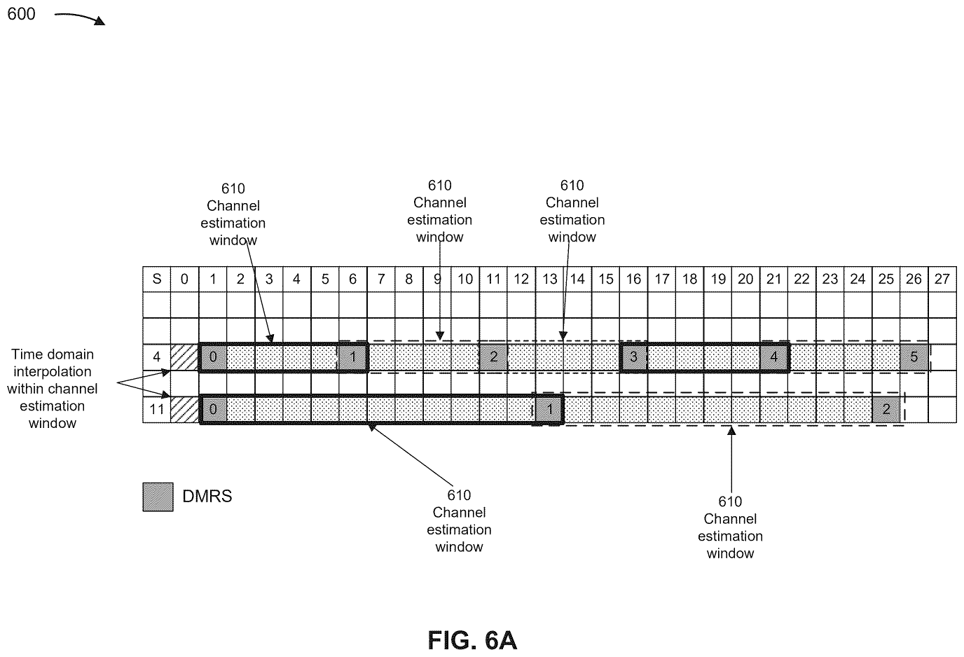

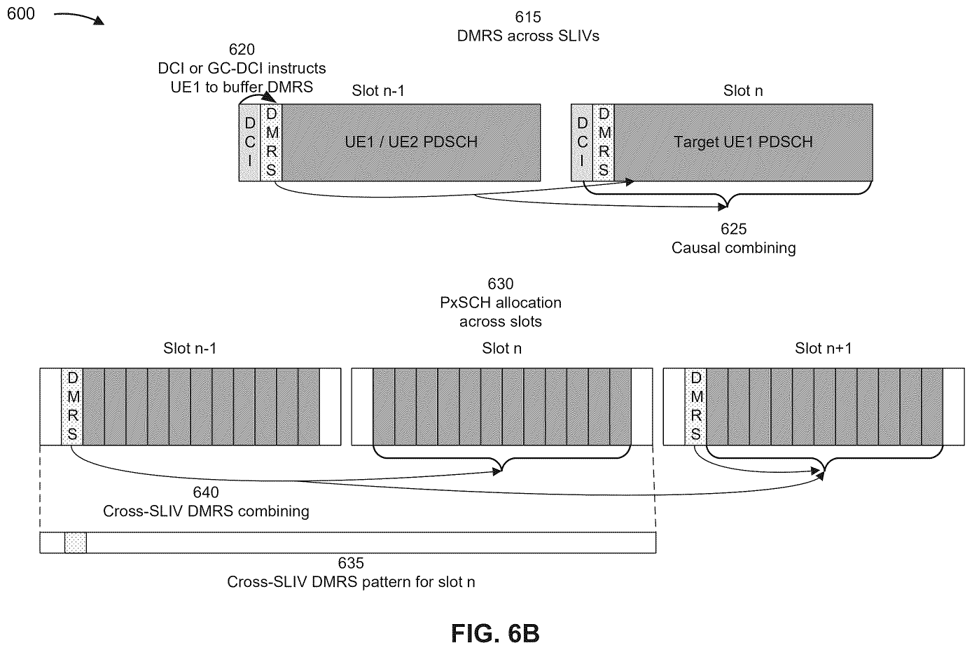

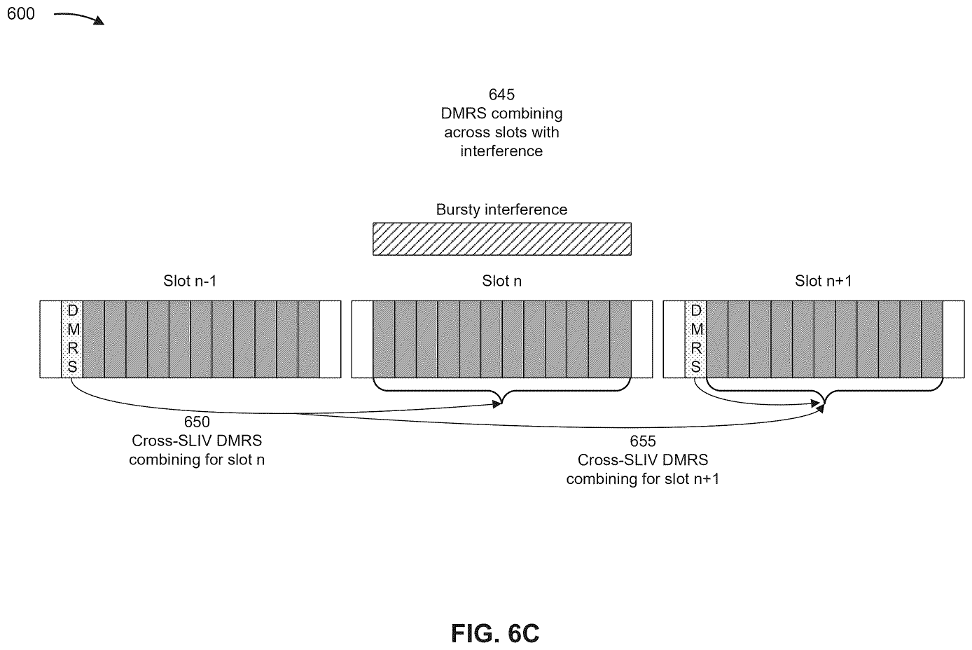

FIGS. 6A-6C are diagrams illustrating examples 600 of SLIV designs for PxSCH transmissions, in accordance with the present disclosure.

In some examples, PxSCH communications may be mapped onto a physical layer that is divided into time resources (e.g., slots) and frequency resources (e.g., RBs). A SLIV may be used to indicate the length of a slot, which may vary depending on the subcarrier spacing associated with network configurations. A UE and/or a network node may utilize multiple segments of adjacent (e.g., back-to-back) symbols to extend the coverage of a PxSCH communication, where each repetition segment may be confined to the boundaries of a transmission slot. For example, repetition segments may be associated with different redundancy versions (RVs) of a PUSCH for purposes of a HARQ mechanism, where each repetition segment is located within the boundaries of a slot.

Additionally, in some examples, a SLIV design may be configured to enable PxSCH allocation across one or more slot boundaries, thereby simplifying the ability to extend coverage across slots. In such a SLIV design, DMRS overhead may be reduced by applying a relatively more uniform time domain DMRS pattern (e.g., incorporating benefits from DMRS and CRS) in circumstances associated with Doppler shift, which may affect the accuracy of the channel estimation process. For example, because the Doppler shift is associated the speed at which the distance changes between a UE and a network node, a DMRS pattern may include adjustments to the number and positioning of DMRS symbols depending on the mobility of the UE, where more frequent and consistently-scheduled DMRS symbols may minimize Doppler shift effects in high mobility UE scenarios.

As shown by reference number 605 in FIG. 6A, overlapping sliding channel estimation windows 610 may be used to adjust (e.g., to reduce) the time domain density of DMRSs. For example, a group of DMRS symbols within a time span (e.g., a channel estimation window) may be used to interpolate the channel across the time domain with respect to different channel estimation windows. In some examples, the size of the channel estimation window for DMRS bundling may depend on a buffer constraint associated with a UE.

In some examples, the DMRSs may be used to capture bursty interference that occurs in isolated instances and/or is present during a single slot or mini-slot. For example, the bursty interference may originate from other cells where a UE is located near the edge of a serving cell, and depending on the characteristics of the interference, it may occur in isolated and/or infrequent instances.

Furthermore, as shown by reference number 615 of FIG. 6B, a DMRS may be shared across SLIVs, which are used to schedule PxSCH communications across more than one slot. In some examples, a combinable DMRS resource in adjacent transmission time intervals (TTIs) may be indicated to a UE, where the UE is instructed to perform cross-SLIV combining of DMRSs, thereby reducing DMRS overhead. For example, and as shown by reference number 620, in a DL communication, DCI or GC-DCI may instruct a UE1 to buffer DMRSs. As shown by reference number 625, the DMRS resources may be causally combined to extrapolate and decode PDSCH symbols.

Additionally, and as shown by reference number 630, PxSCH allocation across slots may result in one or more slots that do not include DMRSs. For example, and as shown by reference number 635, a cross-SLIV DMRS pattern for a slot n may enable allocation of a PxSCH across slots (e.g., across slot n−1 and slot n), but may result in no DMRS being included in slot n. For example, where the DMRS is shared across slots (e.g., via cross-SLIV DMRS combining 640), slot n may not include a scheduled DMRS symbol. Such a scheduling configuration may reduce DMRS overhead, thereby reducing network traffic, increasing the efficiency of resource allocation, and reducing transmit power consumption. For example, such a scheduling configuration may be implemented in circumstances having relatively low Doppler shift effects, where DMRSs may be scheduled with decreased frequency relative to circumstances having relatively high Doppler shift effects.

In some examples, where a DMRS symbol is included in each slot, interference may be estimated according to different interference estimation algorithms. For example, according to a first interference estimation algorithm example, an interference estimation may be based exclusively on DMRSs. For example, a noise covariance matrix, represented as \hat{R}_{NN}, may be determined by:

$${\hat{R}}_{N N} = \frac{1}{N} \sum ( {y}_{i} - {H}_{i} ) {( {y}_{i} - {H}_{i} )}^{′} ,$$

where N represents a total number of samples or data points, Yᵢ represents a received signal vector for a symbol i, and Hᵢ represents a channel matrix for the symbol i.

Similarly, a second interference algorithm example may utilize null tones for non-DMRS symbols in combination with interference associated with DMRS symbols to determine estimated interference. The second interference algorithm example approach captures bursty interference and adds only incremental complexity to DMRS interference. However, the second interference algorithm example approach may result in decreased performance in cases of persistent interference or in cases of no interference.

Additionally, according to a third interference estimation algorithm example, a covariance matrix of a received signal, represented as R_{yy}, may be calculated and used to estimate \hat{R}_{NN} from data tones in a communication. In some examples, R_{yy} may be determined by:

$${R}_{y y} = \frac{1}{N} \sum {Y}_{i} {Y}_{i}^{′} \approx \frac{1}{N} \sum {\hat{H}}_{i} \cdot {\hat{H}}_{i}^{′} + Δ {H}_{i} Δ {H}_{i}^{′} + {G}_{i} \cdot {G}_{i}^{′} + {n}_{i} \cdot {n}_{i}^{′} ,$$

where cross terms are ignored and where N represents a total number of samples or data points, Yᵢ represents a received signal vector for a symbol i, Hᵢ represents a channel matrix for the symbol i, Gᵢ represents a channel gain matrix or a channel matrix for the symbol i, and nᵢ represents a noise signal for the symbol i. The calculated value of R_{yy} may be used to determine \hat{R}_{NN} as:

$${\hat{R}}_{N N} = {R}_{y y} - \frac{1}{N} \sum {\hat{H}}_{i} \cdot {\hat{H}}_{i}^{′} - {N}_{0} I ,$$

where N represents a total number of samples or data points, Yᵢ represents a received signal vector for a symbol i, Hᵢ represents a channel matrix for the symbol i, and I represents an interference signal matrix. The third interference algorithm example approach may capture a spatial signature, which may be suitable for measuring Rank 1 interference (e.g., interference that may originate from a single dominant source or a single linear combination of sources) without rate loss. However, the third interference estimation algorithm example approach may utilize a relatively large number of samples to determine a suitable estimation of \hat{R}_{NN}.

As shown by reference number 645 in FIG. 6C, where a SLIV results in combining of a DMRS across slots, DMRS symbols may be scheduled at less frequent intervals, with some slots containing no DMRS symbols. For example, and as shown by reference number 650, a DMRS associated with slot n−1 may be combined for slot n, and as shown by reference number 655, the DMRS associated with slot n−1 may be combined for slot n+1. Accordingly, because the DMRS from slot n−1 is combined for slot n, there is no DMRS in slot n.

Because a UE and/or a network node may rely on DMRS symbols to capture bursty interference in a network, SLIV configurations that enable a PxSCH to be allocated across a slot boundary may increase the probability that bursty interference interacts with a slot that does not contain a DMRS symbol. As a result, the use of such SLIV configurations may reduce the accuracy of estimating interference where the UE and/or network node fail to capture instances of bursty interference occurring in one or more slots not containing DMRS symbols.

As indicated above, FIGS. 6A-6C are provided as examples. Other examples may differ from what is described with respect to FIGS. 6A-6C.

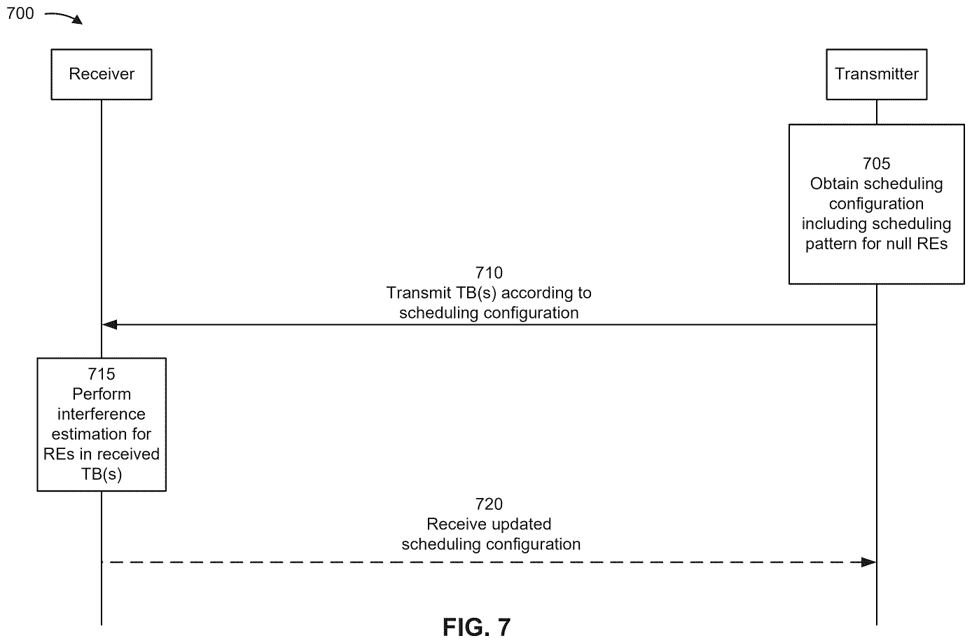

FIG. 7 is a diagram illustrating an example 700 associated with interference estimation using null REs, in accordance with the present disclosure. As shown in FIG. 7, example 700 includes communication between a transmitter (e.g., a UE or a network node) and a receiver (e.g., a UE or a network node). In some aspects, the transmitter and the receiver may be included in a wireless network, such as wireless network 100. The receiver and the transmitter may communicate via a wireless access link, which may include an uplink and a downlink.

As shown by reference number 705, a transmitter may obtain a scheduling configuration associated with a SLIV that defines a time period including at least one slot that does not include a DMRS. The scheduling configuration may indicate a scheduling pattern for one or more sets of REs in the slots that do not include a DMRS, where each set of the one or more sets of REs includes one or more null REs. For example, one or more of the null REs may be an RE having low density and/or associated with minimal or zero power.

In some aspects, the transmitter may puncture one or more REs in a time period by one or more null REs in the time period based on the scheduling configuration. For example, by puncturing one or more REs by one or more null REs, the transmitter may adapt transmissions to different channel conditions in order to decrease transmission overhead as well as to increase the probability of capturing interference when channel conditions include increased instances of interference.

Additionally, in some aspects, the transmitter may rate match each RE in a time period by one or more null REs in the time period based on the scheduling configuration. For example, by rate matching each RE around at least one set of null REs, the transmitter may adapt transmissions to different channel conditions in order to decrease transmission overhead, thereby increasing transmission efficiency while enabling capture of interference (e.g., bursty interference) in relevant slots.

As shown by reference number 710, the transmitter may transmit, and the receiver may receive, one or more TBs according to the scheduling configuration. For example, each TB may include a quantity of REs including one or more null REs.

As shown by reference number 715, the receiver may perform interference estimation for the REs in the received TB(s), including for the null REs. For example, a receiver vector, represented as Nᵣₓ, for the null REs may be given by:

$${Y}_{i} = {G}_{i} {w}_{i} + {n}_{i} ,$$

where i represents an RE index of the null tones (e.g., null tones may be populated in a grid of X tones×Z symbols for one PDSCH, where X and Z may have the same value or may have different values), Yᵢ represents a received signal vector for i, Gᵢ represents a channel gain matrix or a channel matrix for i, wᵢ represents a transmitted signal vector or weight vector for i, and nᵢ represents a noise signal for i.

Accordingly, an estimation of interference (e.g., bursty interference) may be determined for a covariance matrix or correlation matrix, represented as \hat{R}_{BI}, by:

$${\hat{R}}_{BI} = \frac{1}{N} \sum ( {Y}_{i} ) {( {Y}_{i} )}^{′} - {N}_{0} I ,$$

where N represents a total number of samples or data points, Yᵢ represents a received signal vector for a symbol i, and I represents an interference signal matrix.

As shown by reference number 720, the receiver may transmit, and the transmitter may receive, an updated scheduling configuration. In some aspects, the updated scheduling configuration may include an updated scheduling pattern for a quantity of REs in at least one slot, where the scheduling pattern may include an updated set of null REs. Additionally, or alternatively, the transmitter may obtain the updated scheduling configuration from one or more additional sources, including one or more different receivers.

In some aspects, the updated scheduling configuration may enable an active scheduling configuration to be dynamically updated and/or adapted based on existing and/or changing network conditions. For example, a scheduling configuration may indicate a scheduling pattern in which the density and/or periodicity of scheduled null REs in a time period is based on a measured and/or estimated carrier-to-interference-noise ratio (CINR), where a relatively lower density of null REs may be scheduled in low CINR conditions and a relatively higher density of null REs may be scheduled in high CINR conditions.

In some aspects, the receiver may transmit, and the transmitter may receive, more than one updated scheduling configuration, where each updated scheduling configuration includes a scheduling pattern. For example, each scheduling pattern may include a different pattern of null REs scheduled according to different densities and/or periodicities within a time period. For example, the receiver may transmit, and the transmitter may receive, one or more RRC messages indicating multiple null RE patterns having different densities and/or periodicities of null REs within a time period.

In some aspects, the receiver may transmit, and the transmitter may receive, one or more Layer 1, Layer 2, and/or Layer 3 signaling messages to indicate which scheduling pattern the transmitter is to apply. In some aspects, the indication of which scheduling pattern the transmitter is to apply may be based on the expected, measured, and/or estimated CINR values associated with the transmitter. For example, where a receiver is configured to predict expected interference (e.g., via wide burst interference prediction), the receiver may be aware of predicted CINR values for each time segment within a SLIV-defined time period, and as a result, the receiver may dynamically signal null RE patterns (e.g., via one or more null RE pattern indices for multiple null RE patterns) for each time segment associated with predicted interference. For example, the receiver may indicate a scheduling pattern having a relatively lower null RE density for time segments associated with lower predicted CINR values, and the receiver may indicate a scheduling pattern having a relatively higher null RE density for time segments associated with higher predicted CINR values. Additionally, in some aspects, the receiver may transmit null RE patterns (e.g., via one or more null RE pattern indices for multiple null RE patterns) via DCI for each time period in a SLIV that is associated with predicted interference.

As described herein, because a receiver (e.g., a UE or a network node) may rely on DMRS symbols to capture bursty interference in a network, SLIV configurations that enable a PxSCH to be allocated across slot boundaries may increase the probability that bursty interference interacts with a slot that does not contain a DMRS symbol, thereby reducing the accuracy and efficacy of estimating bursty interference. By providing a transmitter (e.g., a UE or a network node) with a scheduling configuration that indicates a scheduling pattern including one or null REs in a time period, a receiver may estimate interference in time periods that include one or more slots having no DMRS symbols. For example, because bursty interference may not be captured in a slot that does not contain a DMRS symbol, a scheduling configuration including null REs within the slot may enable the bursty interference to be captured and utilized for interference estimation. Additionally, by providing one or more updated scheduling patterns to the transmitter, the scheduling of null REs may be adapted to changing network conditions (e.g., increased interference, decreased interference, or the like), thereby enabling increased accuracy and efficacy in estimating interference.

As indicated above, FIG. 7 is provided as an example. Other examples may differ from what is described with respect to FIG. 7.

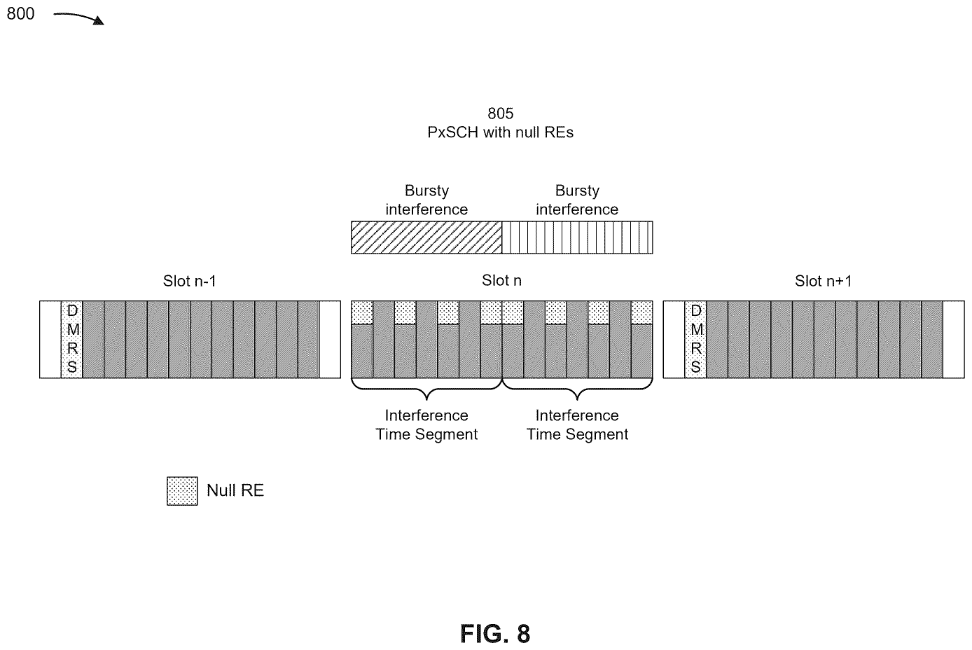

FIG. 8 is a diagram illustrating an example 800 associated with interference estimation using null REs, in accordance with the present disclosure. As shown by reference number 805, a transmitter may obtain a scheduling configuration in which null REs are scheduled in a PxSCH time segment having no DMRS symbols. For example, where slot n contains no DMRS symbols (e.g., where a SLIV indicates a PxSCH allocation across a slot boundary), the scheduling configuration may include a scheduling pattern that indicates the scheduling of one or more null REs within slot n. As described herein, a receiver that receives the PxSCH communication (e.g. via one or more TBs) according to the scheduling configuration may perform at least one interference estimation associated with the null REs of the PxSCH communication. For example, where one or more instances of bursty interference are associated with slot n, interference estimation may be determined based at least in part on the null REs included in slot n.

In some aspects, the scheduling configuration may indicate interference time segments in the SLIV associated with the PxSCH communication based on a potential slot structure. For example, inter-cell interference in a time division duplexing (TDD) network configuration could be slot-based or mini-slot based, and the scheduling configuration may indicate interference time segments accordingly. Additionally, in some aspects, the scheduling configuration may configure null REs within the relevant time segments (e.g., slot or mini-slot) within the SLIV-defined time period(s) that do not include DMRS symbols.

As described herein, SLIV configurations that enable a PxSCH to be allocated across slot boundaries may increase the probability that bursty interference interacts with a slot that does not contain a DMRS symbol, thereby reducing the accuracy of estimating bursty interference. By providing a transmitter with a scheduling configuration that indicates a scheduling pattern including one or null REs in a time period, a receiver may estimate interference in time periods that include one or more slots having no DMRS symbols, thereby increasing the accuracy and efficacy of interference estimation while conserving the benefits of a potentially reduced DMRS overhead.

As indicated above, FIG. 8 is provided as an example. Other examples may differ from what is described with respect to FIG. 8.

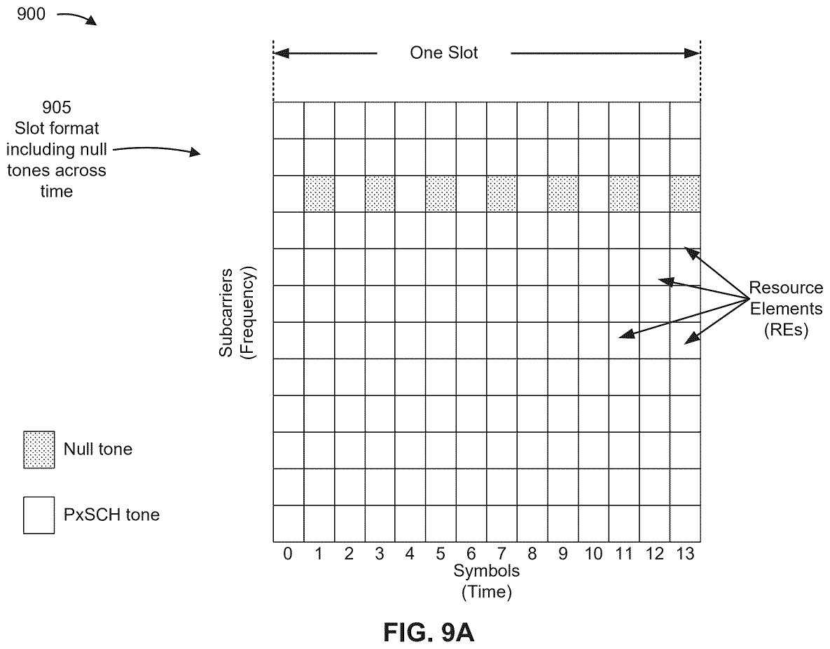

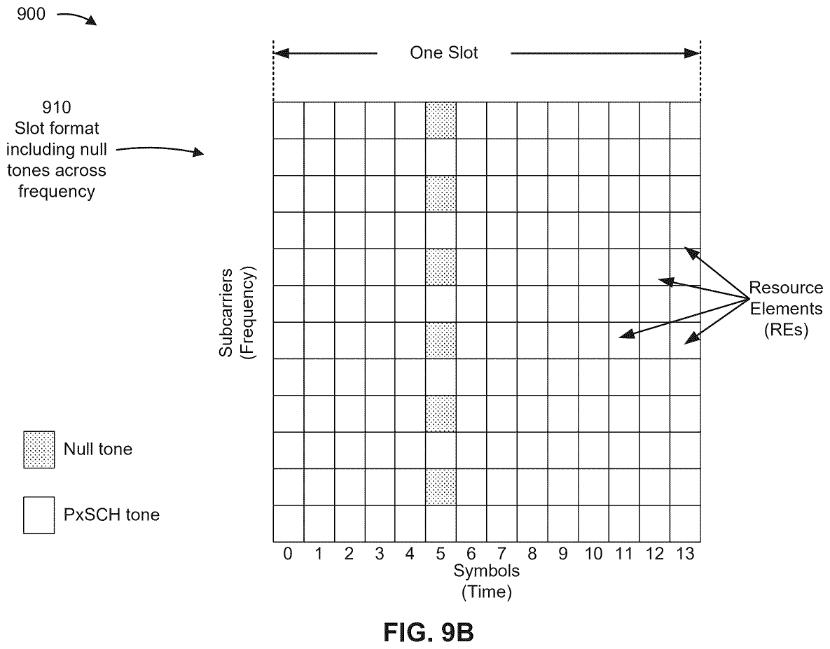

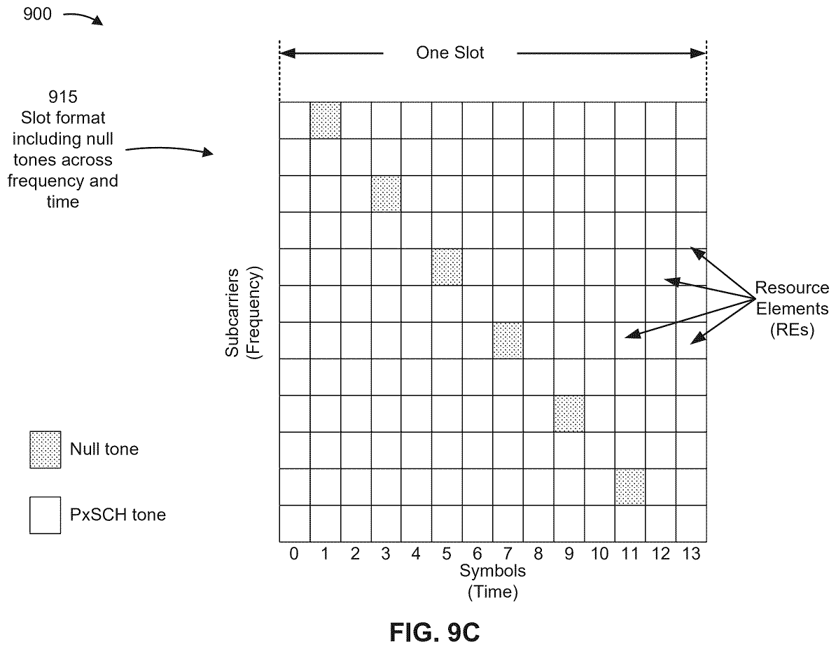

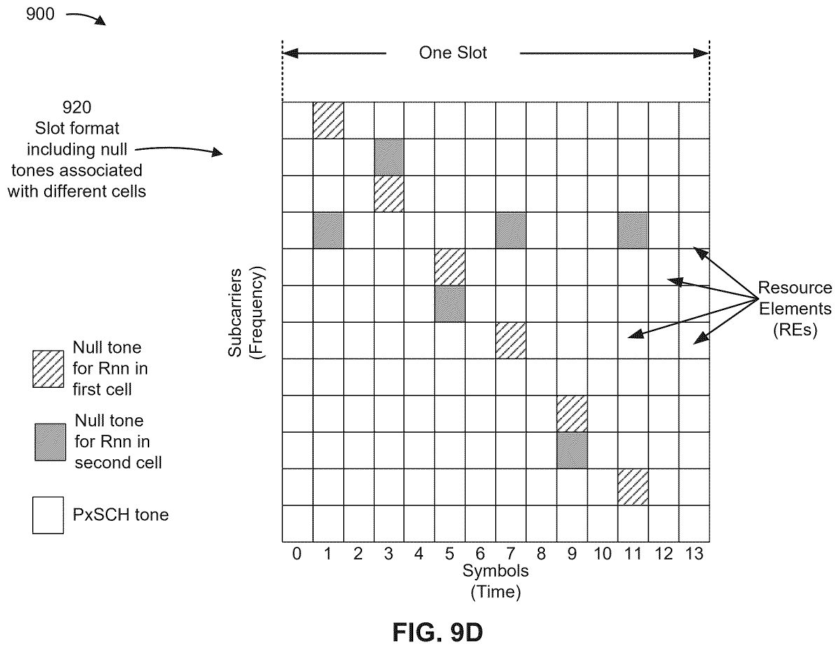

FIGS. 9A-9D are diagrams illustrating examples 900 associated with interference estimation using null REs, in accordance with the present disclosure. In some aspects, where interference is constant across a PRG having no DMRS symbols, null REs may be scheduled in patterns across time and/or frequency in each PRG. For example, null REs may be scheduled to occupy different symbols and/or different RBs.

As shown by reference number 905 in FIG. 9A, a scheduling configuration may indicate a scheduling pattern in which null REs occupy one tone in a PRG for every X symbols, where X is a positive integer. For example, and as shown in FIG. 9A, where the value of X is 2, a null RE may occupy one tone every 2 symbols. In some aspects, the value of X may be configurable by an RRC message. By scheduling null REs as constant across a time period, there is an increased probability that instances of short interference (e.g., instances of interference that occur over a time period that is less than the time period of one slot) will be captured.

Additionally, as shown by reference number 910 in FIG. 9B, the scheduling configuration may indicate a scheduling pattern in which null REs are scheduled in a tone for every Y RBs within a symbol for a range associated with a number of RBs, where Y is a positive integer. For example, and as shown in FIG. 9B, where the value of Y is 2, a null RE may occupy one tone every 2 RBs within a symbol. In some aspects, the value of Y may be configurable by an RRC message. Additionally, in some aspects, the scheduling configuration may include a transmission power variation in order to adapt to varying network conditions (e.g., fading, path loss, interference, or the like) based at least in part on predicted interference for a symbol. By scheduling null REs across RBs within a symbol, interference measurements may be captured consistently across frequency resources, thereby enabling accurate measurement of interference that may be constant or near-constant across a PRG and increasing the probability of capturing short and/or isolated instances of interference that may be predicted to occur in one or more symbols.

Furthermore, as shown by reference number 915 in FIG. 9C, for each PRG of a time segment that does not include a DMRS symbol, the scheduling configuration may indicate a scheduling pattern in which null REs are scheduled in different RBs for different symbols. For example, and as shown in FIG. 9C, the scheduling pattern may indicate scheduling a null RE every 2 symbols and every 2 RBs, where each null RE is scheduled in a different symbol and in a different RB. In some aspects, the scheduling configuration may indicate a scheduling pattern according to an offset and/or separation configuration. In some aspects, the scheduling configuration may indicate the scheduling of each null RE in a different tone of each different symbol according to a reference tone and a tone offset relative to the reference tone. For example, and as shown in FIG. 9C, the scheduling configuration may indicate a reference tone at symbol 1 and the tone offset may indicate scheduling a null RE every 2 symbols and every 2 RBs relative to the reference tone. By indicating a scheduling pattern of null REs according to a reference tone and a tone offset, the transmission overhead of the scheduling pattern may be reduced relative to indicating the scheduling pattern according to a scheduling indication for each null RE, thereby reducing power consumption and network traffic.

Additionally, or alternatively, the scheduling configuration may indicate a scheduling pattern in which more than one null RE may be scheduled in a symbol. In some aspects, the scheduling configuration may indicate a scheduling pattern in which more than one null RE may be scheduled in a symbol based on the number of null REs scheduled in a time period exceeding a quantity of symbols in the time period. For example, where 10 null REs are to be scheduled in 9 symbols of a slot (e.g., out of a total of 14 symbols in the slot), the scheduling configuration may indicate a scheduling pattern in which 2 null REs are scheduled in a single symbol of the 9 symbols in which null REs are scheduled. By scheduling more than one null RE in a symbol, the transmitter may have an increased probability of capturing short, isolated instances of interference as well as interference that is consistent across frequency resources.

As shown by reference number 920 in FIG. 9D, the scheduling configuration may indicate one or more scheduling patterns that include null REs associated with different cells. For example, where two UEs utilize the same null RE scheduling pattern, and where each UE is served by a different, neighboring cell, each UE may be unable to capture inter-cell interference. Accordingly, different cells may be associated with different scheduling patterns for scheduling of null REs. For example, and as shown in FIG. 9D, one or more scheduling configurations may provide a scheduling pattern associated with a first cell and a scheduling pattern associated with a second cell, thereby enabling a UE served by the first cell to schedule a null RE pattern that is different than a null RE pattern in a UE(s) associated with the second cell.

In some aspects, each scheduling pattern may be associated with a cell identification of a cell, where the scheduling configuration may indicate a scheduling pattern based on the cell identification of a cell that is serving the UE. Additionally, or alternatively, where a scheduling configuration indicates a scheduling pattern in which null REs occupy one tone in a PRG for every X symbols, as described herein, different cells may select a different value for X and/or a different starting symbol in which to schedule null REs in a slot in order to increase the probability that inter-cell interference is captured.

In some aspects, where the scheduling configuration indicates a scheduling pattern in which null REs are scheduled in a tone for every Y RBs within a symbol for a range associated with a number of RBs, as described herein, different cells may select a different value for Y and/or a different starting RB in which to schedule null REs in a slot in order to increase the probability that inter-cell interference is captured.

In some aspects, where the scheduling configuration indicates a scheduling pattern in which null REs are scheduled in different RBs for different symbols, the offset and/or separation between null REs may be different for each cell when one or more neighboring cells are present. In some aspects, the scheduling configuration may indicate the scheduling of each null RE in a different tone of each different symbol according to a reference tone and a tone offset relative to the reference tone, where the reference tone and/or the tone offset are different for each cell. Additionally, or alternatively, the reference tone and/or the tone offset may be generated by a random number generator, a hashing function, or the like, where the reference tone and/or the tone offset may be a function of a cell identification, a symbol index, and/or a slot index associated with each cell.

As described herein, SLIV configurations that enable a PxSCH to be allocated across slot boundaries may increase the probability that bursty interference interacts with a slot that does not contain a DMRS symbol, thereby reducing the accuracy of estimating bursty interference. Furthermore, where two or more transmitters are served by two or more neighboring cells that are configured with the same null RE scheduling pattern, inter-cell interference may not be captured due to the lack of differentiation between the scheduled null REs. By associating the scheduling pattern with a cell identification of a cell associated with the transmitter, the transmitter may capture and/or distinguish inter-cell interference. Additionally, by indicating a scheduling pattern of null REs according to a reference tone and a tone offset, the transmission overhead may be reduced relative to indicating the scheduling pattern according to a scheduling indication for each null RE, thereby reducing power consumption and network traffic.

As indicated above, FIGS. 9A-9D are provided as examples. Other examples may differ from what is described with respect to FIGS. 9A-9D.

FIG. 10 is a diagram illustrating an example process 1000 performed, for example, at a transmitter or an apparatus of a transmitter, in accordance with the present disclosure. Example process 1000 is an example where the apparatus or the transmitter (e.g., network node 110 and/or UE 120) performs operations associated with interference estimation using null REs. In some aspects, the transmitter described herein is the network node 110, is included in the network node 110, or includes one or more components of the network node 110 shown in FIG. 1. In some aspects, the transmitter described herein is the UE 120, is included in the UE 120, or includes one or more components of the UE 120 shown in FIG. 1.

As shown in FIG. 10, in some aspects, process 1000 may include obtaining a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs (block 1010). For example, the transmitter (e.g., using reception component 1202 and/or communication manager 1206, depicted in FIG. 12) may obtain a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs, as described above.

As further shown in FIG. 10, in some aspects, process 1000 may include transmitting one or more TBs according to the scheduling configuration (block 1020). For example, the transmitter (e.g., using transmission component 1204 and/or communication manager 1206, depicted in FIG. 12) may transmit one or more TBs according to the scheduling configuration, as described above.

Process 1000 may include additional aspects, such as any single aspect or any combination of aspects described below and/or in connection with one or more other processes described elsewhere herein.

In a first aspect, the scheduling pattern is associated with a cell identification of a cell associated with the transmitter.

In a second aspect, alone or in combination with the first aspect, the scheduling pattern indicates a scheduling of one null RE of the at least one set of null REs in a tone in every X symbols within a PRG of each slot of the at least one slot according to a periodicity associated with a number of symbols, X being a positive integer.

In a third aspect, alone or in combination with one or more of the first and second aspects, the scheduling pattern is configured based at least in part on an RRC configuration.

In a fourth aspect, alone or in combination with one or more of the first through third aspects, the value of X is associated with a cell identification of a cell associated with the transmitter.

In a fifth aspect, alone or in combination with one or more of the first through fourth aspects, the scheduling pattern indicates a scheduling of one null RE of the at least one set of null REs in every Y resource blocks within a symbol of each slot of the at least one slot according to a range associated with a number of resource blocks, Y being a positive integer.

In a sixth aspect, alone or in combination with one or more of the first through fifth aspects, the value of Y is associated with a cell identification of a cell associated with the transmitter.

In a seventh aspect, alone or in combination with one or more of the first through sixth aspects, the scheduling pattern indicates that each null RE of the at least one set of null REs is scheduled in a different symbol and in a different tone within a PRG of each slot of the at least one slot.

In an eighth aspect, alone or in combination with one or more of the first through seventh aspects, the scheduling configuration indicates that more than one null RE of the at least one set of null REs is capable of being scheduled in a symbol, where a quantity of null REs in the at least one set of null REs exceeds a quantity of symbols in which the scheduling pattern indicates that a null RE is to be scheduled.

In a ninth aspect, alone or in combination with one or more of the first through eighth aspects, the scheduling pattern indicates the scheduling of each null RE of the at least one set of null REs in the different tone of each different symbol according to a reference tone and a tone offset relative to the reference tone.

In a tenth aspect, alone or in combination with one or more of the first through ninth aspects, the tone offset is associated with at least one of a cell identification of a cell associated with the transmitter, a symbol index, or a slot index.

In an eleventh aspect, alone or in combination with one or more of the first through tenth aspects, process 1000 includes receiving an updated scheduling configuration indicating an updated scheduling pattern for the plurality of REs in the at least one slot, wherein the updated scheduling pattern includes an updated at least one set of null REs.

In a twelfth aspect, alone or in combination with one or more of the first through eleventh aspects, process 1000 includes puncturing one or more REs of the plurality of REs by one or more null REs of the at least one set of null REs based at least in part on the scheduling configuration.

In a thirteenth aspect, alone or in combination with one or more of the first through twelfth aspects, process 1000 includes rating matching each RE of the plurality of REs around the at least one set of null REs based at least in part on the scheduling configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a receiver or an apparatus of a receiver, in accordance with the present disclosure. Example process 1100 is an example where the apparatus or the receiver (e.g., network node 110 and/or UE 120) performs operations associated with interference estimation using null REs. In some aspects, the receiver described herein is the network node 110, is included in the network node 110, or includes one or more components of the network node 110 shown in FIG. 1. In some aspects, the receiver described herein is the UE 120, is included in the UE 120, or includes one or more components of the UE 120 shown in FIG. 1.

As shown in FIG. 11, in some aspects, process 1100 may include receiving, from a transmitter, one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs (block 1110). For example, the receiver (e.g., using reception component 1302 and/or communication manager 1306, depicted in FIG. 13) may receive, from a transmitter, one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs, as described above.

As further shown in FIG. 11, in some aspects, process 1100 may include performing at least one interference estimation associated with the plurality of REs (block 1120). For example, the receiver (e.g., using communication manager 1306, depicted in FIG. 13) may perform at least one interference estimation associated with the plurality of REs, as described above.

Process 1100 may include additional aspects, such as any single aspect or any combination of aspects described below and/or in connection with one or more other processes described elsewhere herein.

In a first aspect, the scheduling pattern is associated with a cell identification of a cell associated with the transmitter.

In a second aspect, alone or in combination with the first aspect, the scheduling pattern indicates a scheduling of one null RE of the at least one set of null REs in a tone in every X symbols within a PRG of each slot of the at least one slot according to a periodicity associated with a number of symbols, X being a positive integer.

In a third aspect, alone or in combination with one or more of the first and second aspects, the value of X is associated with a cell identification of a cell associated with the transmitter.

In a fourth aspect, alone or in combination with one or more of the first through third aspects, the scheduling pattern indicates a scheduling of one null RE of the at least one set of null REs in every Y resource blocks within a symbol of each slot of the at least one slot according to a range associated with a number of resource blocks, Y being a positive integer.

In a fifth aspect, alone or in combination with one or more of the first through fourth aspects, the value of Y is associated with a cell identification of a cell associated with the transmitter.

In a sixth aspect, alone or in combination with one or more of the first through fifth aspects, the scheduling pattern indicates that each null RE of the at least one set of null REs is scheduled in a different symbol and in a different tone within a PRG of each slot of the at least one slot.

In a seventh aspect, alone or in combination with one or more of the first through sixth aspects, the scheduling pattern indicates the scheduling of each null RE of the at least one set of null REs in the different tone of each different symbol according to a reference tone and a tone offset relative to the reference tone.

In an eighth aspect, alone or in combination with one or more of the first through seventh aspects, the tone offset is associated with at least one of a cell identification of a cell associated with the transmitter, a symbol index, or a slot index.

In a ninth aspect, alone or in combination with one or more of the first through eighth aspects, one or more REs of the plurality of REs are punctured by one or more null REs of the at least one set of null REs.

In a tenth aspect, alone or in combination with one or more of the first through ninth aspects, each RE of the plurality of REs is rate matched around the at least one set of null REs.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a transmitter, or a transmitter may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 and/or the communication manager 155 described in connection with FIG. 1. As shown, the apparatus 1200 may communicate with another apparatus 1208, such as a UE 120 or a network node 110 (such as a CU, a DU, an RU, or a base station), using the reception component 1202 and the transmission component 1204. The communication manager 1206 may be included in, or implemented via, a processing system (for example, the processing system 140 and/or the processing system 145 described in connection with FIG. 1) of the transmitter.

In some aspects, the apparatus 1200 may be configured to perform one or more operations described herein in connection with FIGS. 7, 8, 9A, 9B, 9C, and/or 9D. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the transmitter described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the transmitter described above in connection with FIG. 1, such as a radio, one or more RF chains, one or more transceivers, or one or more modems, each of which may in turn be coupled with one or more antennas of the transmitter.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the transmitter described above in connection with FIG. 1, such as a radio, one or more RF chains, one or more transceivers, or one or more modems, each of which may in turn be coupled with one or more antennas of the transmitter described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may obtain a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The transmission component 1204 may transmit one or more TBs according to the scheduling configuration.

The reception component 1202 may receive an updated scheduling configuration indicating an updated scheduling pattern for the plurality of REs in the at least one slot, wherein the updated scheduling pattern includes an updated at least one set of null REs.

The communication manager 1206 may puncture one or more REs of the plurality of REs by one or more null REs of the at least one set of null REs based at least in part on the scheduling configuration.

The communication manager 1206 may rate match each RE of the plurality of REs around the at least one set of null REs based at least in part on the scheduling configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a receiver, or a receiver may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 and/or the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 and/or the processing system 145 described in connection with FIG. 1) of the receiver.

In some aspects, the apparatus 1300 may be configured to perform one or more operations described herein in connection with FIGS. 7, 8, 9A, 9B, 9C, and/or 9D. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the receiver described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the receiver described above in connection with FIG. 1, such as a radio, one or more RF chains, one or more transceivers, or one or more modems, each of which may in turn be coupled with one or more antennas of the receiver.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the receiver described above in connection with FIG. 1, such as a radio, one or more RF chains, one or more transceivers, or one or more modems, each of which may in turn be coupled with one or more antennas of the receiver described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from a transmitter, one or more TBs according to a scheduling configuration associated with a SLIV defining a time period including at least one slot that does not include a scheduled DMRS, wherein the scheduling configuration indicates a scheduling pattern for a plurality of REs in the at least one slot, wherein the plurality of REs includes at least one set of null REs. The communication manager 1306 may perform at least one interference estimation associated with the plurality of REs.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a transmitter comprising: obtaining a scheduling configuration associated with a start and length indicator value defining a time period including at least one slot that does not include a scheduled demodulation reference signal, wherein the scheduling configuration indicates a scheduling pattern for a plurality of resource elements (REs) in the at least one slot, wherein the plurality of REs includes at least one set of null REs; and transmitting one or more transport blocks according to the scheduling configuration.

Aspect 2: The method of Aspect 1, wherein the scheduling pattern is associated with a cell identification of a cell associated with the transmitter.

Aspect 3: The method of any of Aspects 1-2, wherein the scheduling pattern indicates a scheduling of one null RE of the at least one set of null REs in a tone in every X symbols within a physical resource block group of each slot of the at least one slot according to a periodicity associated with a number of symbols, X being a positive integer.

Aspect 4: The method of Aspect 2, wherein the scheduling pattern is configured based at least in part on a radio resource control configuration.

Aspect 5: The method of Aspect 2, wherein the value of X is associated with a cell identification of a cell associated with the transmitter.

Aspect 6: The method of any of Aspects 1-5, wherein the scheduling pattern indicates a scheduling of one null RE of the at least one set of null REs in every Y resource blocks within a symbol of each slot of the at least one slot according to a range associated with a number of resource blocks, Y being a positive integer.

Aspect 7: The method of Aspect 6, wherein the value of Y is associated with a cell identification of a cell associated with the transmitter.

Aspect 8: The method of any of Aspects 1-7, wherein the scheduling pattern indicates that each null RE of the at least one set of null REs is scheduled in a different symbol and in a different tone within a physical resource block group of each slot of the at least one slot.

Aspect 9: The method of Aspect 8, wherein the scheduling configuration indicates that more than one null RE of the at least one set of null REs is capable of being scheduled in a symbol, where a quantity of null REs in the at least one set of null REs exceeds a quantity of symbols in which the scheduling pattern indicates that a null RE is to be scheduled.

Aspect 10: The method of Aspect 8, wherein the scheduling pattern indicates the scheduling of each null RE of the at least one set of null REs in the different tone of each different symbol according to a reference tone and a tone offset relative to the reference tone.

Aspect 11: The method of Aspect 10, wherein the tone offset is associated with at least one of a cell identification of a cell associated with the transmitter, a symbol index, or a slot index.

Aspect 12: The method of any of Aspects 1-11, further comprising: receiving an updated scheduling configuration indicating an updated scheduling pattern for the plurality of REs in the at least one slot, wherein the updated scheduling pattern includes an updated at least one set of null REs.

Aspect 13: The method of any of Aspects 1-12, further comprising: puncturing one or more REs of the plurality of REs by one or more null REs of the at least one set of null REs based at least in part on the scheduling configuration.

Aspect 14: The method of any of Aspects 1-13, further comprising: rate matching each RE of the plurality of REs around the at least one set of null REs based at least in part on the scheduling configuration.

Aspect 15: A method of wireless communication performed by a receiver, comprising: receiving, from a transmitter, one or more transport blocks according to a scheduling configuration associated with a start and length indicator value defining a time period including at least one slot that does not include a scheduled demodulation reference signal, wherein the scheduling configuration indicates a scheduling pattern for a plurality of resource elements (REs) in the at least one slot, wherein the plurality of REs includes at least one set of null REs; and performing at least one interference estimation associated with the plurality of REs.

Aspect 16: The method of Aspect 15, wherein the scheduling pattern is associated with a cell identification of a cell associated with the transmitter.

Aspect 17: The method of any of Aspects 15-16, wherein the scheduling pattern indicates a scheduling of one null RE of the at least one set of null REs in a tone in every X symbols within a physical resource block group of each slot of the at least one slot according to a periodicity associated with a number of symbols, X being a positive integer.

Aspect 18: The method of Aspect 16, wherein the value of X is associated with a cell identification of a cell associated with the transmitter.

Aspect 19: The method of any of Aspects 15-18, wherein the scheduling pattern indicates a scheduling of one null RE of the at least one set of null REs in every Y resource blocks within a symbol of each slot of the at least one slot according to a range associated with a number of resource blocks, Y being a positive integer.

Aspect 20: The method of Aspect 19, wherein the value of Y is associated with a cell identification of a cell associated with the transmitter.

Aspect 21: The method of any of Aspects 15-20, wherein the scheduling pattern indicates that each null RE of the at least one set of null REs is scheduled in a different symbol and in a different tone within a physical resource block group of each slot of the at least one slot.

Aspect 22: The method of Aspect 21, wherein the scheduling pattern indicates the scheduling of each null RE of the at least one set of null REs in the different tone of each different symbol according to a reference tone and a tone offset relative to the reference tone.

Aspect 23: The method of Aspect 22, wherein the tone offset is associated with at least one of a cell identification of a cell associated with the transmitter, a symbol index, or a slot index.

Aspect 24: The method of any of Aspects 15-23, wherein one or more REs of the plurality of REs are punctured by one or more null REs of the at least one set of null REs.

Aspect 25: The method of any of Aspects 15-24, wherein each RE of the plurality of REs is rate matched around the at least one set of null REs.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitter for wireless communication, comprising:
one or more memories; and
one or more processors, coupled to the one or more memories, configured to cause the transmitter to:
obtain a scheduling configuration associated with a start and length indicator value defining a time period including at least one slot that does not include a scheduled demodulation reference signal, wherein the scheduling configuration indicates a scheduling pattern for a plurality of resource elements (REs) in the at least one slot, wherein the plurality of REs includes at least one set of null REs; and
transmit one or more transport blocks according to the scheduling configuration.

2. The transmitter of claim 1, wherein the scheduling pattern is associated with a cell identification of a cell associated with the transmitter.

3. The transmitter of claim 1, wherein the scheduling pattern indicates a scheduling of one null RE of the at least one set of null REs in a tone in every X symbols within a physical resource block group of each slot of the at least one slot according to a periodicity associated with a number of symbols, X being a positive integer.

4. The transmitter of claim 3, wherein the scheduling pattern is configured based at least in part on a radio resource control configuration.

5. The transmitter of claim 3, wherein the value of X is associated with a cell identification of a cell associated with the transmitter.

6. The transmitter of claim 1, wherein the scheduling pattern indicates a scheduling of one null RE of the at least one set of null REs in every Y resource blocks within a symbol of each slot of the at least one slot according to a range associated with a number of resource blocks, Y being a positive integer.

7. The transmitter of claim 6, wherein the value of Y is associated with a cell identification of a cell associated with the transmitter.

8. The transmitter of claim 1, wherein the scheduling pattern indicates that each null RE of the at least one set of null REs is scheduled in a different symbol and in a different tone within a physical resource block group of each slot of the at least one slot.

9. The transmitter of claim 8, wherein the scheduling configuration indicates that more than one null RE of the at least one set of null REs is capable of being scheduled in a symbol, where a quantity of null REs in the at least one set of null REs exceeds a quantity of symbols in which the scheduling pattern indicates that a null RE is to be scheduled.

10. The transmitter of claim 8, wherein the scheduling pattern indicates the scheduling of each null RE of the at least one set of null REs in the different tone of each different symbol according to a reference tone and a tone offset relative to the reference tone.

11. The transmitter of claim 10, wherein the tone offset is associated with at least one of a cell identification of a cell associated with the transmitter, a symbol index, or a slot index.

12. The transmitter of claim 1, wherein the one or more processors are further configured to cause the transmitter to:
receive an updated scheduling configuration indicating an updated scheduling pattern for the plurality of REs in the at least one slot, wherein the updated scheduling pattern includes an updated at least one set of null REs.

13. The transmitter of claim 1, wherein the one or more processors are further configured to cause the transmitter to:
puncture one or more REs of the plurality of REs by one or more null REs of the at least one set of null REs based at least in part on the scheduling configuration.

14. The transmitter of claim 1, wherein the one or more processors are further configured to cause the transmitter to:
rate matching each RE of the plurality of REs around the at least one set of null REs based at least in part on the scheduling configuration.

15. A receiver for wireless communication, comprising:
one or more memories; and
one or more processors, coupled to the one or more memories, configured to cause the receiver to:
receive, from a transmitter, one or more transport blocks according to a scheduling configuration associated with a start and length indicator value defining a time period including at least one slot that does not include a scheduled demodulation reference signal, wherein the scheduling configuration indicates a scheduling pattern for a plurality of resource elements (REs) in the at least one slot, wherein the plurality of REs includes at least one set of null REs; and
perform at least one interference estimation associated with the plurality of RES.

16. The receiver of claim 15, wherein the scheduling pattern indicates a scheduling of one null RE of the at least one set of null REs in a tone in every X symbols within a physical resource block group of each slot of the at least one slot according to a periodicity associated with a number of symbols, X being a positive integer.

17. The receiver of claim 15, wherein the scheduling pattern indicates a scheduling of one null RE of the at least one set of null REs in every Y resource blocks within a symbol of each slot of the at least one slot according to a range associated with a number of resource blocks, Y being a positive integer.

18. The receiver of claim 15, wherein the scheduling pattern indicates that each null RE of the at least one set of null REs is scheduled in a different symbol and in a different tone within a physical resource block group of each slot of the at least one slot.

19. The receiver of claim 18, wherein the scheduling pattern indicates the scheduling of each null RE of the at least one set of null REs in the different tone of each different symbol according to a reference tone and a tone offset relative to the reference tone.

20. The receiver of claim 19, wherein the tone offset is associated with at least one of a cell identification of a cell associated with the transmitter, a symbol index, or a slot index.

21. A method of wireless communication performed by a transmitter comprising:
obtaining a scheduling configuration associated with a start and length indicator value defining a time period including at least one slot that does not include a scheduled demodulation reference signal, wherein the scheduling configuration indicates a scheduling pattern for a plurality of resource elements (REs) in the at least one slot, wherein the plurality of REs includes at least one set of null REs; and
transmitting one or more transport blocks according to the scheduling configuration.

22. The method of claim 21, wherein the scheduling pattern indicates a scheduling of one null RE of the at least one set of null REs in a tone in every X symbols within a physical resource block group of each slot of the at least one slot according to a periodicity associated with a number of symbols, X being a positive integer.

23. The method of claim 21, wherein the scheduling pattern indicates a scheduling of one null RE of the at least one set of null REs in every Y resource blocks within a symbol of each slot of the at least one slot according to a range associated with a number of resource blocks, Y being a positive integer.

24. The method of claim 21, wherein the scheduling pattern indicates that each null RE of the at least one set of null REs is scheduled in a different symbol and in a different tone within a physical resource block group of each slot of the at least one slot.

25. The method of claim 21, further comprising:
receiving an updated scheduling configuration indicating an updated scheduling pattern for the plurality of REs in the at least one slot, wherein the updated scheduling pattern includes an updated at least one set of null REs.

26. A method of wireless communication performed by a receiver, comprising:
receiving, from a transmitter, one or more transport blocks according to a scheduling configuration associated with a start and length indicator value defining a time period including at least one slot that does not include a scheduled demodulation reference signal, wherein the scheduling configuration indicates a scheduling pattern for a plurality of resource elements (REs) in the at least one slot, wherein the plurality of REs includes at least one set of null REs; and
performing at least one interference estimation associated with the plurality of REs.

27. The method of claim 26, wherein the scheduling pattern is associated with a cell identification of a cell associated with the transmitter.

28. The method of claim 26, wherein the scheduling pattern indicates that each null RE of the at least one set of null REs is scheduled in a different symbol and in a different tone within a physical resource block group of each slot of the at least one slot.

29. The method of claim 28, wherein the scheduling pattern indicates the scheduling of each null RE of the at least one set of null REs in the different tone of each different symbol according to a reference tone and a tone offset relative to the reference tone.

30. The method of claim 29, wherein the tone offset is associated with at least one of a cell identification of a cell associated with the transmitter, a symbol index, or a slot index.
